(19) United States
(12) Patent Application Publication
(10) Pub. No.: US 2024/0229554 A9
(43) Pub. Date: Jul. 11, 2024

(54) CORNER CONNECTOR STRUCTURE OF SCREEN APPARATUS

(71) Applicant: Taroko Door & Window Technologies, Inc., GAOXIONG CITY (TW)

(72) Inventor: Yimin WANG, GAOXIONG CITY (TW)

(21) Appl. No.: 18/278,624

(22) PCT Filed: Jan. 22, 2022
(86) PCT No.: PCT/CN2022/073323

§ 371 Date: Aug. 24, 2023

(30) Foreign Application Priority Data
Mar. 17, 2021 (CN) 202110284184.9
Jan. 22, 2022 (WO) PCT/CN2022/073323

(51) Int. Cl. E06B 9/52

(52) U.S. Cl. CPC E06B 9/52

(57) ABSTRACT

A corner connector structure of a screen apparatus includes bodies (1), the body (1) being at least provided with a first connecting part (11) and a second connecting part (12) which is separated from the first connecting part (11) by an angle, a combining groove (13) being provided at the position of the first connecting part (11) and/or the second connecting part (12) of the body (1), and a wire adjuster (20) being provided in the combining groove (13). By means of the corner connector structure, when a screen is opened or closed and a track wire (30) swings due to stress, the track wire (30) does not swing out of the track of a frame material (201), so that the problem that when the screen is opened or closed, the screen is unsmoothly opened or closed or gets stuck easily can be solved.

### TECHNICAL FIELD

The present invention relates to a corner connector structure, in particular to a corner connector structure used for a screen apparatus such as a folding screen or a rolling bar screen.

### BACKGROUND ART

A currently used screen apparatus, including both a folding screen window and a rolling bar screen window, often uses a plurality of wheel bodies to bypass a track wire or uses a wire adjusting apparatus to adjust the tightness of the track wire. However, due to such a structural configuration that the current wheel body or the wire adjusting apparatus is assembled on a frame material of a window frame, when a screen is opened or closed, the track wire is prone to swing due to stress, leading to the situation that the track wire often swings out of the track of the window frame, which is prone to result in the situation that the screen is unsmoothly opened or closed or gets stuck when the screen is subsequently opened or closed.

### SUMMARY OF THE INVENTION

According to the technical solution of the present invention, a corner connector structure of a screen apparatus, including bodies, the body being at least provided with a first connecting part and a second connecting part which is separated from the first connecting part by an angle, a combining groove being provided at the position of the first connecting part and/or the second connecting part of the body, and a wire adjuster being provided in the combining groove.

The present invention has the beneficial effects that the present invention mainly aims to provide a corner connector structure of a screen apparatus; according to the corner connector structure of a screen apparatus, mainly a track wire is accommodated in a wire adjuster of the corner connector; thus, in a case that the track wire swings due to stress when a screen is opened or closed, the situation that the track wire swings out of a track of a frame material is avoided, so that the problem that the screen is unsmoothly opened or closed or gets stuck easily when a screen is opened or closed can be solved.

### BRIEF DESCRIPTION OF THE DRAWINGS

FIG. 1 is a schematic view of a frame body formed by the present invention and frame materials.

FIG. 2 is a three-dimensional schematic view of the present invention.

FIG. 3 is a schematic exploded view of a body in the present invention.

FIG. 4 is a schematic exploded view of a wire adjuster in the present invention.

FIG. 5 is a cross-sectional view of the wire adjuster in the present invention.

### DETAILED DESCRIPTION

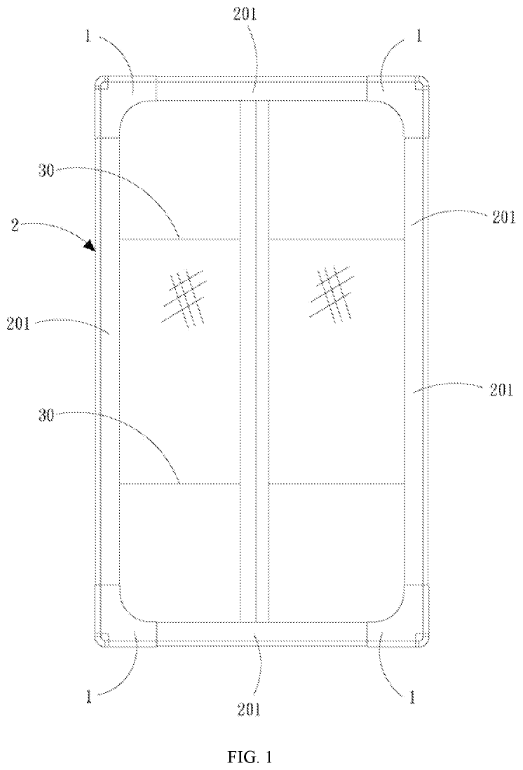

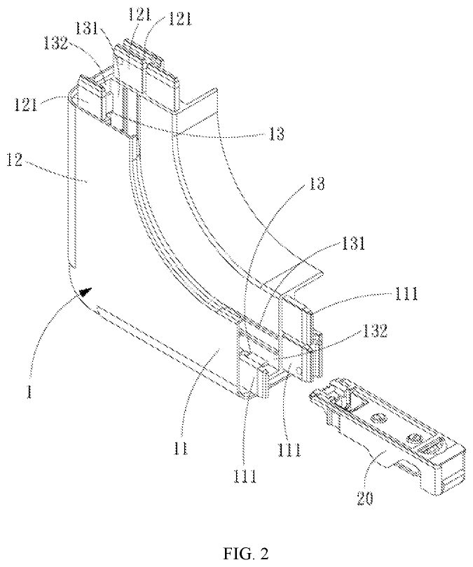

Please refer to FIG. 1 to FIG. 3, a preferable embodiment of a corner connector structure of a screen apparatus of the present invention mainly includes bodies (1), the body (1) being at least provided with a first connecting part (11) and a second connecting part (12) which is separated from the first connecting part (11) by an angle, the first connecting part (11) being at least provided with a first combing piece (111), and the second connecting part (12) being at least provided with a second combing piece (121). However, since frame materials (201) of a frame body (2) are each provided with a recessed groove, in this embodiment, the first combining piece (111) and the second combining piece (121) are both an inserting piece, so the first connecting part (11) and the second connecting part (12) are each provided with three inserting pieces to be inserted and fixed in the recessed groove of the frame material (201). Thus, in this embodiment, the frame body (2) can be formed by means of the plurality of frame materials (201) and the plurality of bodies (1). Further, it is preferable that the first connecting part (11) is separated from the second connecting part (12) by 85-95 degrees. Furthermore, the body (1) can be assembled in a one-piece molding or two-piece manner.

Please refer to FIG. 1 to FIG. 3, a combining groove (13) is provided at the position of the first connecting part (11) and/or the second connecting part (12), the combining groove (13) is at least provided with an opening (131) and a lateral notch (132), and a wire adjuster (20) is provided in the opening (131). In this embodiment, only the wire adjuster (20) being assembled in the combining groove (13) of the first connecting part (11) is illustrated, however the present invention is not limited thereto.

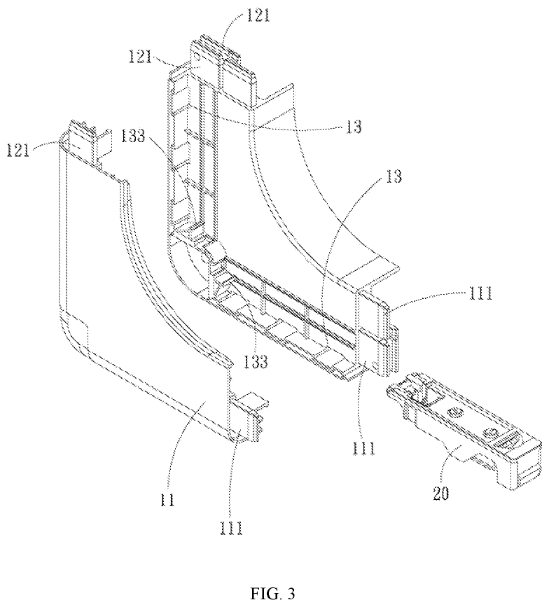

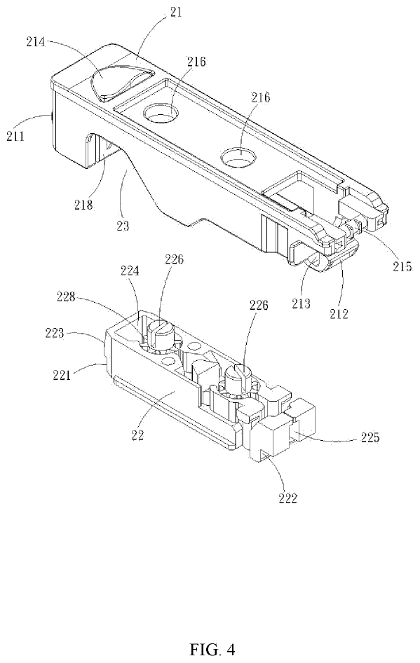

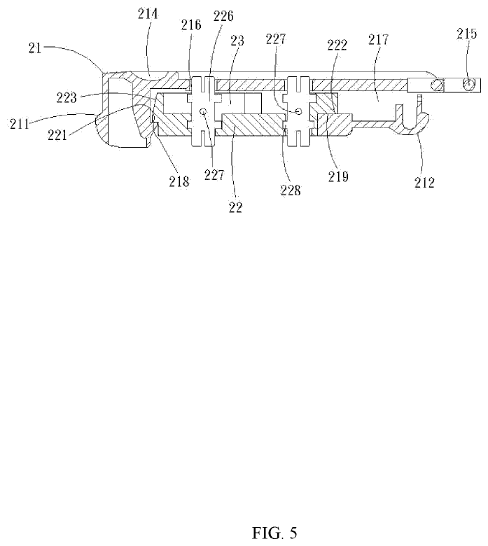

Please refer to FIG. 3 to FIG. 5, the wire adjuster (20) includes a fixing base (21) and a wire adjusting base (22). The fixing base (21) is provided on the opening (131) of the combining groove (13) of the frame body (1). The fixing base (21) is provided with a convex clamping part (211) and a fastener (212) relative to the outer side of the opening (131) of the combing groove (13). The convex clamping part (211) protrudes out of the peripheral edge of the fixing base (21) by a distance. The position of one groove wall of the combining groove of the body (1) opposite to the fastener (212) is provided with an abutting butt part (133). Besides, the fastener (212) is sheet-shaped. One end portion of the fastener (212) is connected to the fixing base (21). The other end portion of the fastener (212) is separated from the fixing base (21) by a distance and forms a compression space (213). The compression space (213) is greater than the distance by which the convex clamping part (211) protrudes out of the peripheral edge of the fixing base (21). The top of the fixing base (21) is provided with a pushing part (214) and a wire returning part (215). In this embodiment, the pushing part (214) is a recessed groove, the wire returning part (215) is a rod body, and the structure of the pushing part (214) and the wire returning part (215) is not limited to the foregoing. Further, the bottom of the fixing base (21) is provided with an accommodating groove (23), and the accommodating groove (23) is provided with at least one through hole (216) towards the top of the fixing base (21) and at least one wire inlet (217) at the position of the wire returning part (215). A first limiting protruding part (218) and a second limiting protruding part (219) are provided in the accommodating groove (23).

Please refer to FIG. 3 to FIG. 5, the wire adjusting base (22) is accommodated in the accommodating groove (23) of the fixing base (21), and the wire adjusting base (22) is provided with a first recessed part (221) and a second recessed part (222) relative to the first limiting protruding part (218) and the second limiting protruding part (219) of the fixing base (21). The position of the wire adjusting base (22) close to the first recessed part (221) is provided with a guiding bevel (223). In the process that the wire adjusting base (22) is accommodated in the accommodating groove (215) of the fixing base (21). The end of the wire adjusting base (22) being provided with the second recessed part (222) first obliquely extends into the accommodating groove (215) of the fixing base (21). Then, the other end of the wire adjusting base (22) is in contact with the first limiting protruding part (218) of the fixing base (22) by means of the guiding bevel (223), so that the other end of the wire adjusting base (22) can slide into the accommodating groove (215) of the fixing base (21) along the guiding bevel (223). At this moment, the first recessed part (221) and the second recessed part (222) of the wire adjusting base (22) can be right attached to the first limiting protruding part (218) and the second limiting protruding part (219) of the fixing base (21), so that the wire adjusting base (22) can be accommodated in the accommodating groove (23) of the fixing base (21) without the risk of falling.

Further, please refer to FIG. 3 to FIG. 5, the wire adjusting base (22) is provided with an actuating groove (224) and a wire incoming groove (225) relative to the through hole (216) and the wire inlet (217) of the fixing base (21). At the position where the wire incoming groove (225) is communicated with the actuating groove (224), a rotating shaft (226) is further provided in the actuating groove (224), and the rotating shaft (226) is provided with a wire tying hole (227) and annularly provided with a plurality of convex tooth parts (228).

Further, as shown in FIG. 3 to FIG. 5, in use of this embodiment, first a track wire (30) passes through the wire returning part (215) of the fixing base (21), so that the track wire (30) is folded back to enter the wire inlet (217) of the fixing base (21) and the wire incoming groove (225) of the wire adjusting base (22) and then enters the actuating groove (224). Then the track wire (30) is fixed to the wire tying hole (227) of the rotating shaft (226). Next, the wire adjusting base (22) is assembled in the accommodating groove (215) of the fixing base (21), so that the rotating shaft (226) can be limited between the fixing base (21) and the wire adjusting base (22), and one end of the rotating shaft (226) is enabled to be accommodated in the through hole (216) of the fixing base (21). Next, the fixing base (21) stretches into the opening (131) of the combining groove (13) of the body (1), and the fastener (212) can be jointed to the abutting joint part (133) of the fixing base (21). The frame material (201) then abuts against the convex clamping part (211), thereby enabling the fixing base (21) to be elastically clamped in the opening (131) of the combining groove (13), so that the risk that the fixing base (21) falls out of the combining groove (13) of the body (1) is avoided. When the track wire (30) is too tight or loose, the rotating shaft (26) in the wire adjusting base (22) can be loosened or tightened by means of the through hole (216) on the fixing base (21), so that the track wire (30) is always maintained at a proper tension. Since the track wire (30) enters the fixing base (21) and the wire adjuster (22) by means of the recessed groove of the frame material (201), when the track wire (30) swings due to stress when a screen is opened or closed, the track wire (30) is provided in the recessed groove of the frame material (201), when the track wire swings due to stress, the situation that the track wire swings out of the track of the frame material (201) is avoided, so this embodiment can really solve the problem that when the screen is opened or closed, the screen is unsmoothly opened or closed or gets stuck easily.

The above described embodiment is only intended to illustrate the technical idea and features of the present invention, is implemented to make all the persons skilled in the art know the content of the present invention, and cannot be constructed as limiting the scope of the present invention. Equivalent changes or modifications made on the basis of the spirit of the present invention and the content of the description all fall within the scope of the present invention.

What is claimed is:

1. A corner connector structure of a screen apparatus, comprising bodies, the body being at least provided with a first connecting part and a second connecting part which is separated from the first connecting part by an angle, a combining groove being provided at the position of the first connecting part and/or the second connecting part of the body, and a wire adjuster being provided in the combining groove.

2. The corner connector structure of a screen apparatus according to claim 1, wherein the first connecting part is separated from the second connecting part by 85-95 degrees.

3. The corner connector structure of a screen apparatus according to claim 1, wherein the first connecting part is at least provided with a first combing piece, and the second connecting part is at least provided with a second combing piece.

4. The corner connector structure of a screen apparatus according to claim 3, wherein both the first combing piece and the second combining piece are an inserting piece.

5. The corner connector structure of a screen apparatus according to claim 1, wherein the combining groove further comprises an opening and a lateral notch, and the combing groove protrudes out relative to the side wall of the lateral notch to form an abutting joint part.

6. The corner connector structure of a screen apparatus according to claim 5, wherein the wire adjuster further comprises a wire adjusting base and a fixing base, the wire adjusting base is assembled and combined with the fixing base, and the fixing base is provided in the opening of the combing groove of the body.

7. The corner connector structure of a screen apparatus according to claim 6, wherein the peripheral edge of the fixing base is at least provided with a fastener, the fastener is attached to the upper side and the lower side of the abutting joint part of the body, and the fastener has a compression space.

8. The corner connector structure of a screen apparatus according to claim 6, wherein the fixing base is provided with an accommodating groove, and the wire adjusting base is accommodated in the accommodating groove; a first limiting protruding part and a second limiting protruding part are provided in the accommodating groove, and the wire adjusting base is provided with a first recessed part and a second recessed part relative to the first limiting protruding part and the second limiting protruding part of the fixing base.

9. The corner connector structure of a screen apparatus according to claim 6, wherein the fixing base is provided with at least a through hole, the wire adjusting base is provided with an actuating groove relative to the through hole of the fixing base, a rotating shaft is provided in the actuating groove, and the rotating shaft is annularly provided with a plurality of convex tooth parts.

10. The corner connector structure of a screen apparatus according to claim 1, wherein the first connecting part and the second connecting part are each combined with a frame material of a frame body.
